(19) United States
(12) Patent Application Publication
(10) Pub. No.: US 2016/0196565 A1
(43) Pub. Date: Jul. 7, 2016

(54) CONTENT PUBLISHING GATEKEEPING SYSTEM

(71) Applicant: Greg BIBAS, Irvine, CA (US)

(72) Inventor: Greg BIBAS, Irvine, CA (US)

(21) Appl. No.: 14/590,415

(22) Filed: Jan. 6, 2015

(51) Int. Cl. G06Q 30/02; G06F 17/30

(52) U.S. Cl. CPC G06Q 30/0203; G06F 17/30867; G06F 17/30507; G06F 17/30528; G06F 17/3089

(57) ABSTRACT

The present disclosure is a gatekeeper method and/or system that automatically creates and distributes a survey that initially has filtering applied to possible questions based on information about the user to create the appropriate question set. The system uses the information including comments and answers in the response to questions in the survey, and other information available about the user, and through the application of an algorithm determines whether to allow the user to publish content concerning the survey.

### BACKGROUND OF THE DISCLOSURE

1. Field of the Disclosure

The present disclosure relates to an application and/or system that is a gatekeeper to content publication on the Internet and other electronic networks. In particular, the present disclosure relates to a gatekeeper method and/or system that automatically creates and distributes a survey that initially has filtering applied to possible questions based on information about the user to create the appropriate question set, and using information including comments and answers in the response to questions in the survey, and other information available about the user, and through the application of an algorithm determines whether to allow the user to publish content concerning the survey.

2. Description of the Related Art

There are various steps consumers often must follow to publish content currently online. These steps range from the simplest version of the process that includes typing or loading content (such as an image, video or other rich media) to be published and clicking a submit button, or using some other command, to indicate approval to post the material to more complex processes. Such complex processes often include site or account registration, sharing of personally identifiable information, answering of simple yes/no questions, multiple choice questions or open ended response questions, requiring reading and confirmation of terms and conditions on individual websites, and various other more complex information requests. There are various examples of systems designed to determine when, if, and how a customer receives a survey from a business, based upon purchase behavior, payment behavior, or other criteria learned and stored about the customer or the individual transaction.

There are also processes that require submission of answers to questions in which the answers to the question may determine some dependent action, such as applications for employment, or applications for entry to a university, and where the qualifications and answers provided are used to make a decision about an action or event that is dependent upon the answers provided to the asked questions.

There are other services that use surveys and survey-like interfaces, such as Yelp!, Tripadvisor, Amazon, and others, to allow a user to evaluate a product, service, or location through the answers to various questions about the subject product, service, event, location of other object of the survey.

Currently available processes use provided information to create unbiased sources of reviews and opinions. However, these processes are not optimal and are flawed in several substantial ways. For example, reviews of movies, restaurants or other reviews often have subjective criteria associated with them. Further, the personal preferences of the individual mean that what might be a good experience for one group of consumers will not be a good experience for another group of consumers. One consumer might give a rating of 0 and another might give a rating of 10 for the exact same object of the rating simply based upon their own subjective evaluation. Others who have not yet experienced the object of this rating (A restaurant, movie, product, and the like) may see an average rating of 5 (an averaging of the 0 and the 10) and/or the individual component ratings, and not have a good understanding of whether they individually would be likely to rate the same object of the rating a 0 or a 10. Another similar example would be that of a political poll, where personal beliefs can make different candidates and positions preferable to different audiences, and ratings or reviews from everyone are less valuable to the consumer of that information.

Currently available processes are designed for the needs of the consumers of the ratings, and not for the owner or operator of the object of the rating. The producer of the movie, the owner of the restaurant or business, or the manufacturer of the product, are not considered the beneficiaries or the prime purpose of these ratings, except tangentially if the ratings are positive. It is believed that ratings and reviews are currently generally viewed as only of value to a consumer when all ratings, both positive and negative, are included. Further, often the internal survey results of businesses of their own customers do not match the results that are available through various sources of review results.

Online content, such as reviews, may be skewed by people who were never customers or users of the product or service, but who have other motives for providing negative commentary or feedback, such as competitors of various forms. Such online content may also be skewed because of selection bias. For example, where those who decide to publish comments are disproportionately dissatisfied, because those who were satisfied do not feel the need to take action, whereas those who were dis-satisfied either want some form of apology or compensatory response, and utilize complaints as a tool to achieve their objectives, thereby skewing the overall impression of the object of the rating to others seeking information about the object of the rating.

The present systems also provides benefit to the object of the survey when responses are negative. There is often no easy mechanism to learn from the consumer what went wrong in the experience or what the business or other user might do to improve the survey for future customers quickly enough to address and rectify the negative experience before that consumer has shared their poor experience and before the poor experience is irrecoverable. Current approaches do not provide the ability to quickly identify which customers are having negative experiences and, do not appreciate that it is most important to reach these customers quickly to rectify their complaints.

### SUMMARY OF THE DISCLOSURE

The present disclosure provides a method and/or a system that is a gatekeeper to content publication on the Internet and other electronic networks.

The present disclosure further provides such a gatekeeper method and/or system that automatically creates and distributes a survey that initially has filtering applied to possible questions based on information about the user to create the appropriate question set, and using information including comments and answers in the response to questions in the survey, and other information available about the user, and through the application of an algorithm, determines whether to allow the user to publish content concerning the survey.

The present disclosure still further provides such a gatekeeper method and/or system that presents, in a timely manner, an end user with an appropriately selected set of questions regarding the object of a survey if the end user qualifies based on the rules defined by the requestor, and allows a user to input answers to specific questions and add additional comments, prior to publishing.

The present disclosure yet further provides such a gatekeeper method that permits data and details about the questions answered, the user, and the initial experience that the user is answering questions about, to be stored for subsequent use.

The present disclosure also provides such a gatekeeper method that incorporates selected information from external databases of information to allow the system to determine which questions to select, which questions in what question set, and what priority in each question set to include in the possible questions to use in the creation of question sets to send to the user as a survey.

The present disclosure further provides such a gatekeeper system that connects to the destination source where the content will be published, and allows the user to input access credentials to connect and authorize the system to publish the content on their behalf. Thus, the present disclosure provides such a gatekeeper method and system for a requestor to request that a survey about a product, service, event, or other experience be sent to a user (their customer), and that the system can utilize information available from the requestor about the user and their interaction history in addition to information available about the user from external sources, for example in the case of a retail requestor purchase history, satisfaction history, income, age, sex, education level, purchase intent, and other proprietary requestor data or commercially available data points to select appropriate questions to be included in the survey to he sent to the user. Upon receipt of answers from the user to the survey, the system has a rule set for each requestor to identify the relative importance of individual questions, and the acceptable answer thresholds to individual questions or sets or groups of questions as a filter applied to user answers in the survey, as well as other information available, such as, but not limited to, location, time, previous history of responses, and in addition to information available from the requestor about the user and all available external data previously mentioned, to determine whether to permit the user to publish content, such as their review or comments, to a destination, such as social network, blog, and other content repository, as well as to deter mine the relative importance of addressing negative feedback of the user (i.e., a customer with frequent large past purchases from the requestor, a high credit rating, and high income, or one with a large online social network who is active in communicating positively and negatively about product and service experiences, can cause the requestor to prioritize the immediate handling of negative feedback from such a customer over a customer who has never purchased before, has a low income and a low credit rating, made a small single purchase, or one with a small inactive online social network.

These and other objects and advantages of the present disclosure are achieved by a method and/or system that includes creating an account for a requestor; using information about a prior experience, product or other object of a survey to select possible questions that most accurately determine possible satisfaction or dis-satisfaction of a user or customer with specific elements or components of the experience; providing the requestor with tools to distribute the survey/questions to one or more of their users (recipients); displaying the questions to the users (recipients); providing each user with tools to answer the questions; storing the answers to those questions; using the answers or information derived from the answers of a user to calculate, using an algorithm, whether to allow that user to publish his/her comments and any additional commentary and content (text, images, video and the like) to a content repository (such as a social network); using a computer to format the content to publish so that the value to others of the product, service, experience, or other object of the survey are highlighted; providing an immediate access and authorization to post the content on behalf of the user to various destinations including, but not limited to, social networks such as Facebook; and providing access to other consumers (i.e., other people whom the users are connected with on Facebook can see that this posted information and what the review was) of that content, and to details and other marketing material about the product, service, business or other object of the survey.

The method and system of the present disclosure provides functionality to request, automatically create and distribute surveys to one or more end users or customers by wireless communication protocol through receipt by SMS (text messages on cell phones), email, and/or through applications installed on recipient mobile devices.

While the present disclosure will be discussed primarily in the context of providing a method and/or system for assisting a business or other type requestor to create, send, analyze and post content to one or more social media networks by their users who are satisfied with their experience, the present disclosure can be adapted to a number of other applications. The other applications can include, but are not limited to, the choice and promotion of a particular idea or political candidate (i.e., political polling and political marketing, where a citizen may agree with specific political views on individual issues—via a poll/survey—with an individual candidate, and those areas of agreement might be used as an automated filtering mechanism to posting of politically promotionally oriented content by a candidate—with approval by the citizen—to the citizen's social network), the marketing and promotion of individual products and brands (i.e. where the proximate experience can be with a retailer, but the consumer experience with the brand, such as a car brand or a consumer packaged goods brand, can be identified through answers provided by consumers, and where promotionally oriented content could be published to a consumer's social media account by a brand upon approval by the consumer), consumer research and automated streamlining of content into streams of like-minded content.

### BRIEF DESCRIPTION OF THE DRAWINGS

FIG. 1 is a schematic of the system of the present disclosure.

FIG. 2 is a schematic of the centralized management system of the system of FIG. 1.

FIG. 3 is a flow diagram of an aspect within the centralized management system of the system of FIG. 1.

FIG. 4 is a flow diagram of the present disclosure that shows the steps taken between initiating a survey and either resulting in published content or feedback received.

FIG. 5 is a detailed example showing the application of an example rule of the present system.

FIG. 6 is also a second detailed example showing the application of an example rule of the present system.

### DETAILED DESCRIPTION OF THE PREFERRED EMBODIMENTS

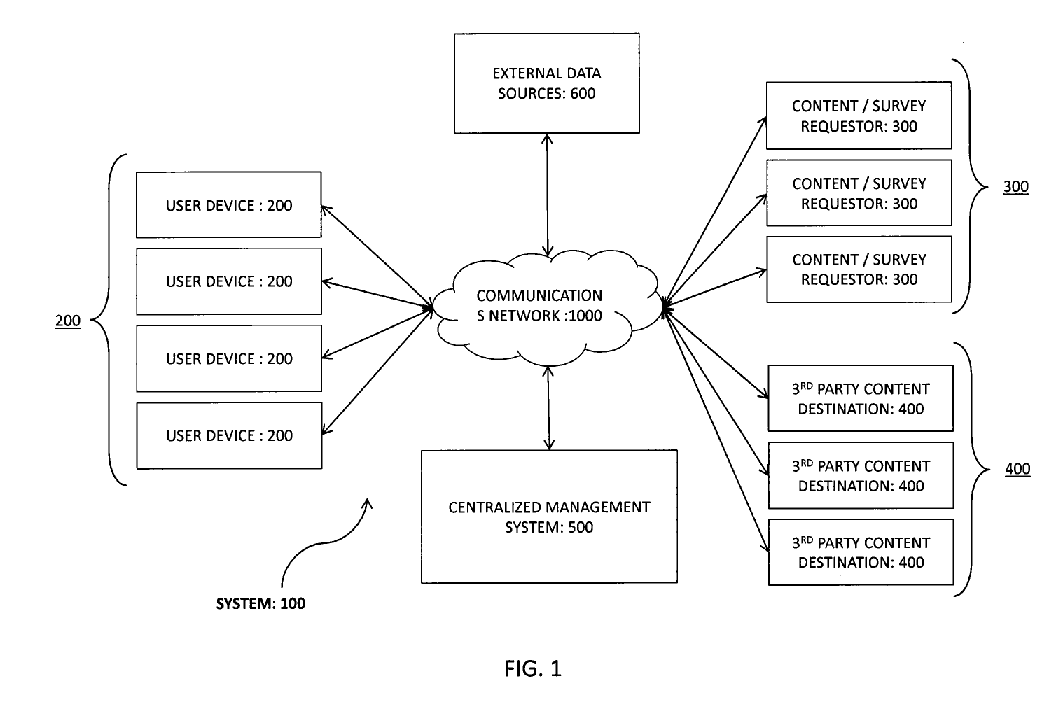

Referring to the drawings and, in particular, to FIG. 1, there is shown an embodiment of a system of the present disclosure generally represented by reference numeral 100. System 100 operates in conjunction with a communication network 1000, that may or may not be part of system 100, and includes a centralized management system 500. System 100 can also have, or have operative connections to, one or more user devices 200, one or more content/survey requestors 300, one or more third party content destinations 400 and one or more external data sources 600, all operatively connected via communications network 1000 to centralized management system 500. Communications network 1000 provides or includes bi-directional connections and communications therethrough between or amongst management system 500 and user device 200, requestor 300, one or more third party content destinations 400, and one or more external data sources 600. Communications network 1000 can include wired or wireless networks, a computer network, such as the Internet or a LAN, and/or phone networks, including the public telephone network, cell phone network and SMS (cell phone text network). Furthermore, the communications protocol used by communications network 1000 can vary, depending upon, for example, the particular application. Communications network 1000 is, in a preferred embodiment, the public internet.

For the present system 100, requestor 300 obtains an account in centralized management system 500 using communication network 1000. Specifically, the requestor 300 enters data such as their business name, address, city, state, zip code, phone number, email address, website address, Facebook business page address, hours of operation, industry, and billing information. Once requestor 300 creates an account with centralized management system 500, based on the industry of requestor 300, a generalized pool of questions will be shown to the requestor as possible questions appropriate for their surveys. Requestor 300 then can select weights for the relative importance of those questions to their business and customer base. Requestor 300 can thereafter also request that the survey be sent to one or more of their users (their consumers/customers) via the system 100 by inputting an email address, SMS phone number, or via an application connection between a user's device and centralized management system 500. Communications network 1000 sends a user survey electronically via at least one user device 200 via email, SMS or direct connection with an installed application on the USER device.

The specific survey is created by centralized management system 500 based on several inputs of data to generate the overall pool of questions. Such data inputs include the industry of requestor 300, historical data stored by requestor 300 about the user, 3^{rd} party data available about the user based on personally identifiable information captured by centralized management system 500 or stored by requestor 300. For example in the case of a retail requestor 300, such data includes purchase history, satisfaction history, income, age, sex, education level, purchase intent, and other proprietary requestor data or commercially available data points, and identification of any questions previously answered by the same user or consumer in response to surveys sent by the requestor 300 or by another requestor who is using system 100. This, in turn, means that different users can receive different questions in their surveys, and the same user can receive different questions in subsequent surveys that they take with the same requestor. In this particular embodiment, a mobile smart phone device will allow the user to respond to the survey by clicking on responses to each question, and upon the user submitting the response, system 100 will store the responses from the user in centralized management system 500 in table 515 along with any relevant and appropriate data from available external data sources 600 such as, but not including, the date, time and location that the survey was completed, whether the user or customer has completed other surveys from requestor 300 or from other systems or clients, and the values of any 3^{rd} party data used in the calculation of whether to allow publishing or not of the user's survey result and associated comments, and the like. Examples of additional data about individual users can be available from 3^{rd} party data sources, include but are not limited to, purchase intent of different product categories, creditworthiness from credit bureaus, income, age, and other demographics. These pieces of information, which can be associated with a phone number, a name, an email or some combination of those pieces of information or associated with other personally identifiable information stored by requestor 300 can be used to access or purchase other data from 3^{rd} party data sources and store such data in conjunction with the survey results to allow requestor 300 to learn more about the user who is responding and who is satisfied with the service, experience, or other object of the survey. System 100 uses rules, (for example utilizing the combination of the value of the answer of the final question of the survey, which may always be kept the same for that requestor 300, and the value of the weighted average answer of the other questions in that individual survey, utilizing individual pre-defined or calculated weights from requestor 300) built into centralized management system 500 and stored specifically for each requestor 300 in 517 and the account database for that requestor 300 to determine whether centralized management system 500 will allow the user to publish content to a third (3^{rd}) party content destination 400. As more data is collected, it is anticipated that more complex algorithms will be created for specific industries and or specific requestors to maximize publishing, sharing, and results for that requestor. One example of this more complex algorithm can include automated regression modeling on individual key user demographic or purchase attributes to score importance of an individual user to achieve wide social sharing, and propensity to write positive commentary as scored by automated natural language processing on previous comments written by the same user across all prior requestors and/or other surveys processed by the system 100 for this user. These sets of questions are created and ordered for different business types from individual questions input into centralized management system 500. Such input can be by a system operator or electronically by known way of electronically inputting data or information. Questions include for example information on price, service, wait times, cleanliness, availability, knowledge, support, and the like. Each specific business type and interaction type is measured by different criteria, and the set of possible initial questions selected as the pool of potential questions to be asked will be selected based on the typical criteria that a user or consumer would use to rate or evaluate that specific business, destination or other object of the survey.

Requests to distribute links to surveys are made by requestor 300 via centralized management system 500 can be sent to one or more user devices 200. Receipt of the link to the survey in this particular embodiment of central management system 500 is anticipated either via email, text message (SMS), or direct application connection to user device 200 that can be a smart phone device, computer or tablet. The user can then call up his/her survey by clicking on the link on their user device 200.

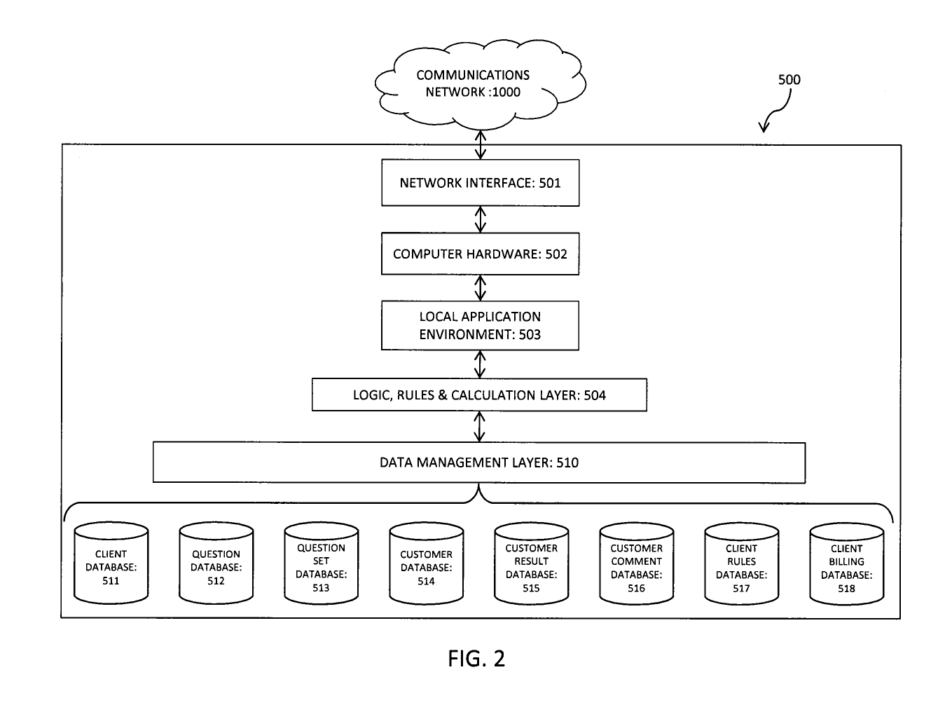

FIG. 2 is an exemplary embodiment of centralized management system 500. Communications network 1000 is connected to centralized management system 500 via a network interface 501 that is in centralized management system 500.

Centralized management system 500 also has computer hardware 502 that connects to network interface 501 and provides a platform upon which the local application environment 503 operates. Local application environment 503 is the aggregation of programming that operates the interconnection of elements, such as user device 200 and requestor 300 to central management system 500, of system 100 of the present disclosure. Centralized management system 500 also has a logic, rules and calculation layer 504. Layer 504 uses the rules set defined for each requestor 300 in 517, in conjunction with data captured and available from requestor 300 and external sources 600, to calculate what to do immediately upon submission by the user of their completed survey (i.e. to allow publishing to the destination location or not). Layer 504 can manage and control the flow of data between the system 500 and user device 200 and the data management layer 510, storing the question set sent to the user and the user's responses to the same and upon calculating the stored algorithm(s) against the user supplied responses and the data available about the user, layer 504 determines whether the user can publish their comments and responses to the destination system (i.e. for example to Facebook or other social network). An example of an individual rule set 517 managed by the data management layer 504, is as follows:
1) Do not allow sending of the request for a survey under the following circumstances:
a. If the user currently has a credit account balance outstanding with requestor 300 of more than $1000 with a past due balance, has made less than $5000 in total purchases, does not own a home, and does not have children living in the house;
b. If the user has a credit score below 580;
c. If the user has received previous surveys in the past 60 days from requestor 300; and
d. If the user has responded to more than 10 surveys in the past 18 months from any requestor in system 500 and less than 6 of those surveys have allowed the user to publish content previously.
2) Upon sending a survey to user and receipt of response, do not allow publishing of results or associated comments under the following circumstances:
a. If the average of the answers to the first 4 questions of the survey are less than 7 or the answer to the last question is less than 8; and
b. Identify all previous submissions to requestor surveys, and if more than 75% of them did not pass the rule set to become publishable, do not allow this submission to publish if the average of the answers of the first 4 questions are less than 8 or the answer to the last question is less than 9.

These limited examples of individual rules for each requestor, utilizing both responses to questions as well as rules to determine who is eligible to receive surveys are designed to provide a tangible example of the use of responses, information available from requestor 300, information available to the operator of system 100, and information available from external data sources. The specific rules appropriate for each requestor is determined uniquely based on their needs.

The data management layer 510 connects with and manages various databases 511 to 518. 512 through 518 are individual data tables that store information of client database 511. The requestor business information, such as name, address, city, state, zip, phone, website address, Facebook address, and the like, along with the individually set weights to the questions selected for requestor are in question database 512. A question database 512 has all possible questions that might be asked any user for any requester. A customer (or user) database 514 has information stored about specific users. For example, such information includes name, address with city, state and zip code, email address, phone number, age of the user and the like type information. Question set database 513 contains pre-defined sets of questions out of questions stored in question database 512. These pre-defined sets of questions are applicable to specific requestor types. A customer result database 515 has users or customer responses (for example customers of requestors 300 defined in client database 511). A database of the survey questions sent to users and results of those survey questions are stored in customer comment database 516 (A subset from question set database 513 sent to a customer database 514 are based on the client or requestor rules stored in client rules database 517). Any additional comments that a user has added to the survey results in additions to the answers to the survey questions, and the additional comments are also stored in customer comment database 516. A database 517 also has the rules to apply to a specific requestor in terms of publishing comments and survey results from their users. Client billing database 518 has requestor 300's billing information and billing history.

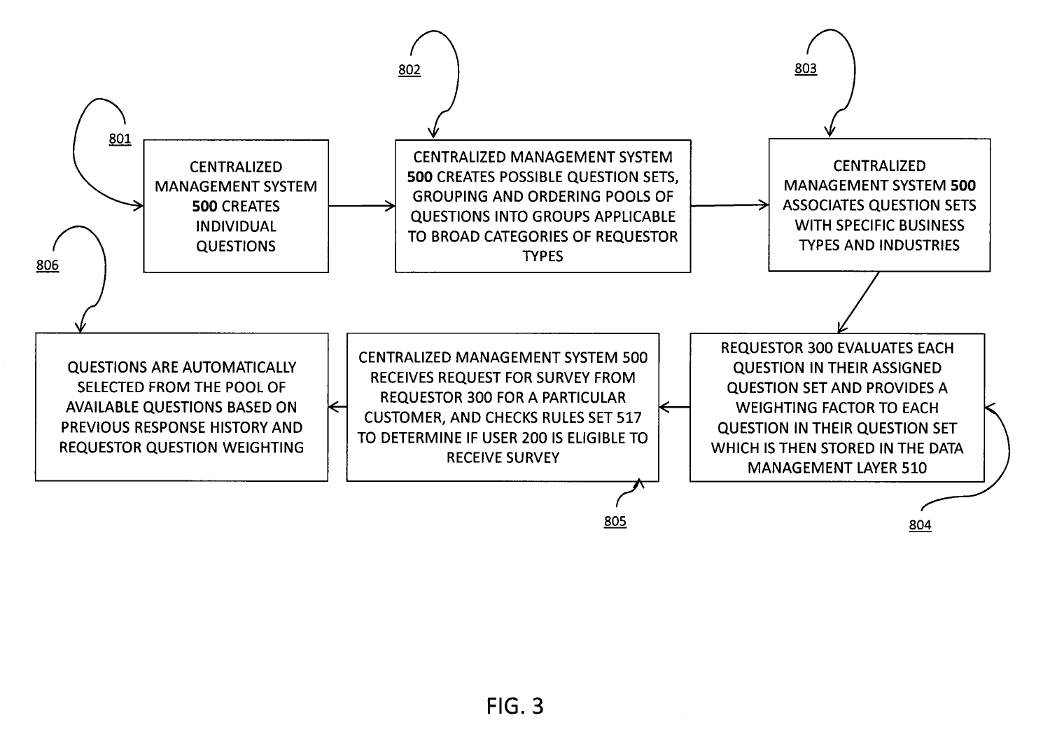

Referring to FIG. 3, the steps of centralized management system 500 are shown. First, at 801, centralized management system 500 creates a database of all individual questions that are anticipated to be needed for all requestors. At 802, these questions are grouped into all appropriate questions for each requestor type. This grouping can be done electronically or, if minimal in number, by an operator. Questions are then, at 803, associated with specific industries based on appropriateness of individual questions to specific industries. At step 804, requestor evaluates each question in their assigned question set. The requestor can provide or assign their own unique weighting factors to each question in the question set to determine the importance of individual questions on the question pool for their industry and business. The weighing factors to each question are then stored in data management layer 510. Upon centralized management system 500 receipt of a request for a survey to be sent to a particular customer or user, centralized management system 500, operating on a computer, checks client rules database 517 for the rules of the requestor, and gathers data from system 500, the requestor, and external data sources 600 as necessitated by the specific rules in client rules database 517 for the requestor, to calculate the associated algorithms for the rules in client rules database 517 and then applies the results as a filter on the request for a survey to be sent. If the survey is to be sent, in step 806, questions are automatically selected by first starting with all questions in the associated question set, then sorting questions based on the weighting factors provided by requestor in step 804, and further by applying any rules from client rules database 517 as to frequency of questions to be asked repeatedly vs. only one instance.

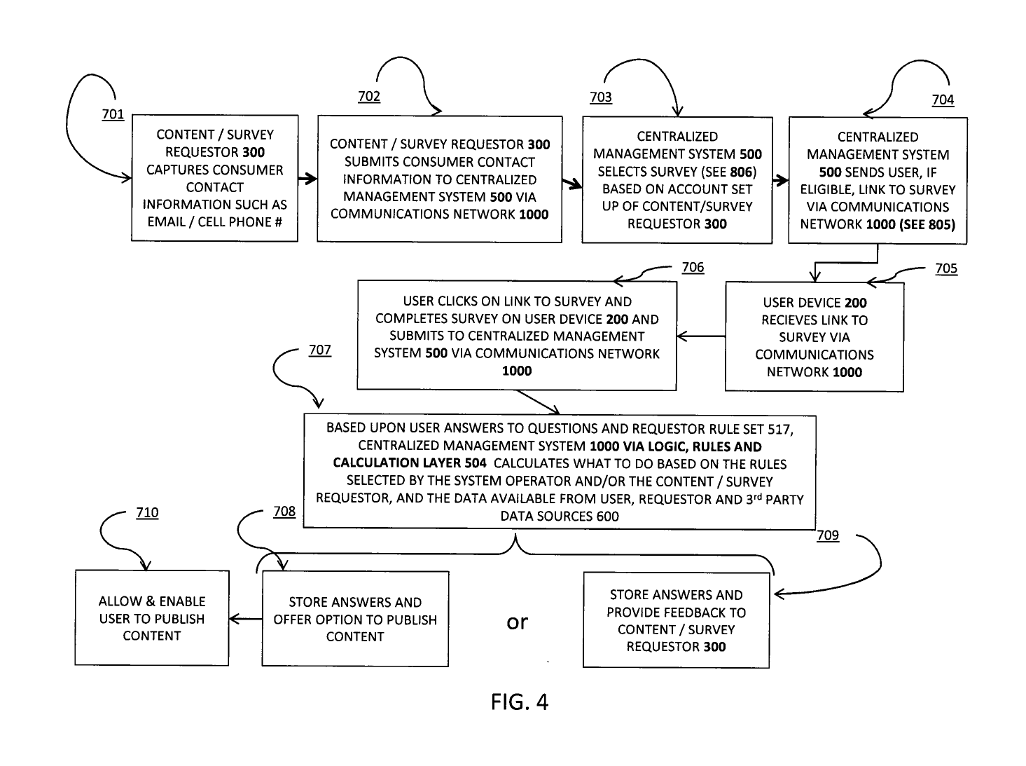

FIG. 4, shows an example of the process flow that requestor 300 goes through to operate the system 100. The process commences when requestor 300, that has contact information of its user (customer), such as an email address and/or cell phone number, sends this information to centralized management system 500 via the communication network 1000. Centralized management system 500 uses the question set associated with the industry of requestor 300 at step 703 and sends the user 200 a link via the communications network 1000 at step 704 if the user is eligible to receive it (based on step 805). The user device 200 then, at step 705, receives the link. Once the user clicks on the link on its user device 200, the survey will be seen and the user has the opportunity to respond to the survey questions at step 706. Depending upon the answers to the questions in the survey, the logic rules and calculation layer 504 uses the responses from the user and any associated data from requestor 300 and/or external databases 600 as inputs to the algorithms stored as rules in client rules database 517 to calculate results to each of the rules and determine, at step 707, what happens after the survey is complete. If it is determined at step 707 that the answers have “passed” the rules in client rules database 517 of requestor 300, the answers are stored, and the user is offered the option to publish the questions and content of their survey answers along with additional comments and content of the user at step 708, and that, in turn, leads to step 710 where the content is enabled for publication if the user so chooses. However, if the system at step 707 determines that the answers have not “passed” the rules stored in client rules database 517 and calculated in step 707 of the requestor 300 the answers are stored, and the user is offered the opportunity to add additional information that is sent to requestor 300. To allow the business to find out what they are doing wrong and to improve it, and no option is provided to publish the user content.

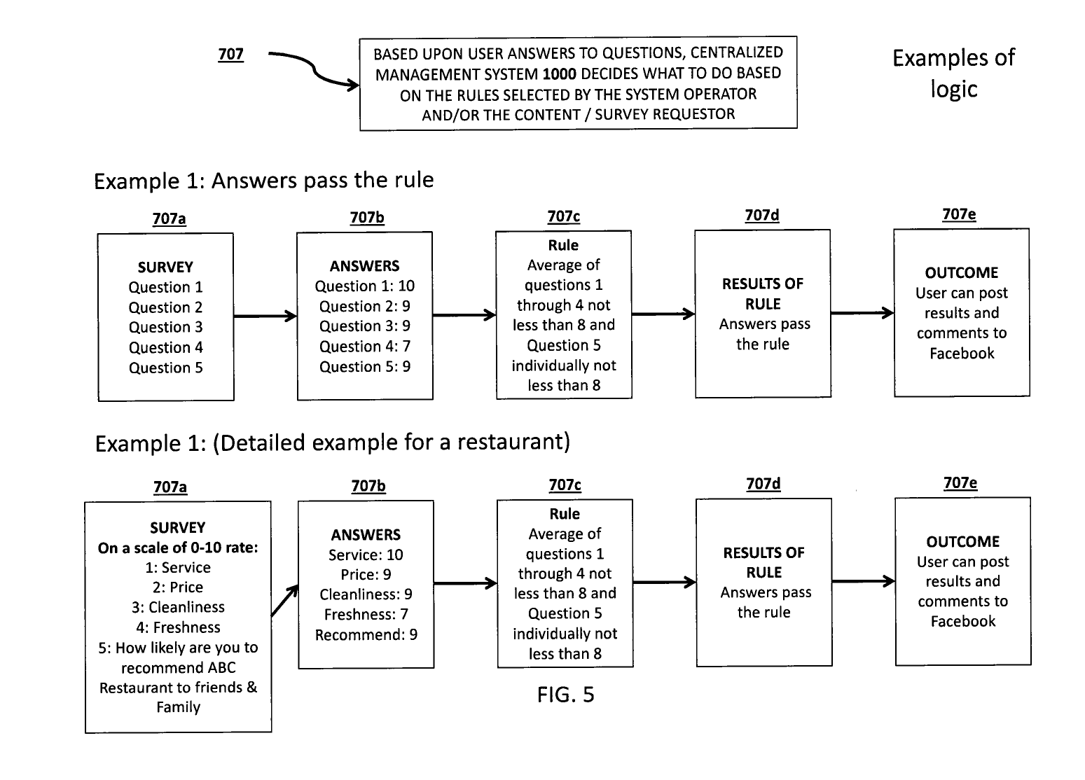

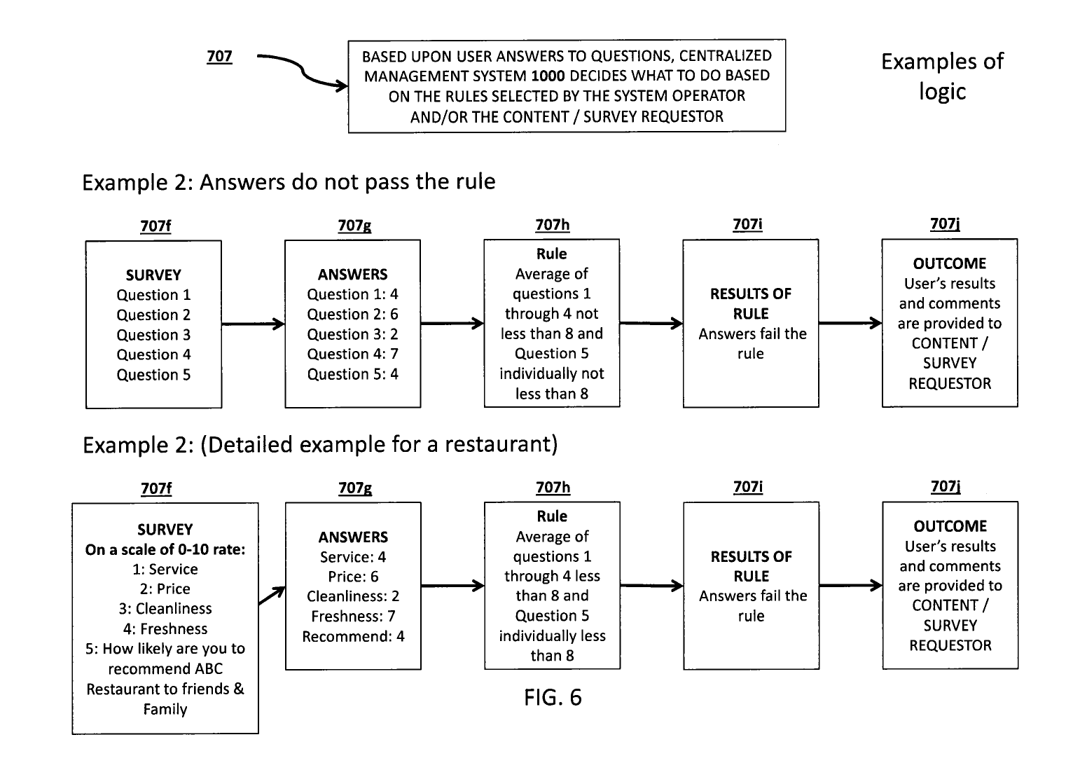

FIG. 5 is a generic example of step 707 in which a rule is passed, and FIG. 6 is a generic example of step 707 in which a rule is not passed. In steps 707a through 707e in FIG. 5, the process of sending a user a survey 707a, receiving the user's answers 707b, applying a rule created for this embodiment of the system that applies a set of numerical calculations that are stored as rules in 517 for each requestor to the data collected in the answers to the surveys to determine if the specific survey “passes” the rule. In this example, the results do pass the rule in step 707d. This “passing” leads to the outcome in step 707e where the user can publish their content. The example 707f through 707j in FIG. 6 shows the same process of sending the user a survey 707f, receiving the user's answers 707g, applying a rule created for this embodiment that applies a set of numerical calculations to the data collected in the answers to the surveys to determine if the specific survey does not pass the rule. In this example, the results do not pass the rule, see step 707i, leading to the outcome in step 707j where the user's results and comments are provided to requestor 300.

What I claim is:

1. A method for controlling the publication of content comprising:
creating for a requestor a survey by filtering possible questions based on information about a user to create an appropriate question set in the survey;
automatically sending the survey to the user based on a request; and
using information including comments and answers in the response to questions in the question sets in the survey and an algorithm to determine whether to allow the user to publish content concerning the survey.

2. The method of claim 1, further comprising applying a set of rules used to the information from the user in the survey in order to determine whether to allow the user to publish content.

3. The method of claim 1, wherein the creation of the survey can include other information available about the user.

4. The method of claim 3, wherein the other information available about the user can include the industry of requestor, historical data stored by requestor about the user, and third party data available about the user based on personally identifiable information.

5. The method of claim 4, wherein the historical data includes purchase history, satisfaction history, income, age, sex, education level, purchase intent, and identification of any questions previously answered by the same user in another survey sent by the requestor.

6. The method of claim 1, wherein the information about the user to create the survey can determine which questions to select, which questions in what question set, and what priority in each question set.

7. The method of claim 1, wherein creating the survey is achieved by
creating a database of all individual questions that are anticipated to be needed for all requestors;
grouping the questions into all appropriate questions for each requestor type; and
associating the questions with specific industries based on appropriateness of individual questions to specific industries.

8. The method of claim 7, wherein requestor assigns weighting factors to each question in the question set to determine the importance of individual questions on the question pool for their industry and business.

9. The method of claim 1, wherein the requestor and the user are not the same entity.

10. The method of claim 1, wherein the requestor can request that the survey be sent to one or more of their users.

11. A system for controlling the publication of content comprising:
creating for a requestor a survey for a user by filtering possible questions based on information about the user to create one or more an appropriate question sets in the survey and storing the question sets in a centralized management system;
automatically sending the survey via a communications network to the user based on a request; and
using information including comments and answers from the user in the response to questions in the question sets in the survey and an algorithm in the centralized management system to determine whether to allow the user to publish content concerning the survey.

12. The system of claim 11, wherein creating the survey is achieved by
creating in the centralized management system a database of all individual questions that are anticipated to be needed for all requestors;
grouping, using an algorithm, the questions into appropriate questions for each requestor type, wherein each requestor type is in specific industries or another industry closely associated with one or more specific industries; and
associating the questions with the one or more specific industries based on appropriateness of individual questions concerning the specific industries.

13. The system of claim 11, wherein requestor provides weighting factors to each question in the question set to determine the importance of individual questions for their industry and business.

14. The system of claim 11, wherein the centralized management system has a client rules database, and wherein the centralized management system is operated on a computer and receives the request for the survey to be sent to the user and checks the rules of the requestor.

15. The system of claim 14, wherein the rules are algorithms, and wherein the checks of the client rules database includes use of the algorithms to obtain results which results are applied as a filter to modify the survey before sending to the user.

16. The system of claim 11, wherein the centralized management system gathers, in the database, data from the system, the requestor, and one or more external data sources as necessitated by rules in a client rules database.

17. The system of claim 11, wherein questions are automatically selected by first starting with all questions in the associated question set, then sorting questions based on the weighting factors provided by requestor and by applying rules from client rules database.

18. The system of claim 17, wherein the rules from client rules database include a rule as to frequency of questions to be repeatedly asked vs. asked only once.

19. The system of claim 11, further comprising an operative connection to a communication network.

20. The system of claim 19, further comprising operative connections via the communications network, to one or more user devices, one or more content/survey requestors, one or more third pasty content destinations, and one or more external data sources.
